(19) United States
(12) Patent Application Publication
(10) Pub. No.: US 2005/0249910 A1
(43) Pub. Date: Nov. 10, 2005

(54) Mineral wool covered with complexes formed of organic polymer laminates

(76) Inventors: Alberto Coloma Campal, Guadalajara (ES); Gabriel Navarro Niedercorn, Madrid (ES); Beningno Susilla Garcia, Guadalajara (ES)

Correspondence Address: DUANE MORRIS, LLP;IP DEPARTMENT, 30 SOUTH 17TH STREET, PHILADELPHIA, PA, 19103-4196, US

(21) Appl. No.: 11/092,448

(22) Filed: Mar. 29, 2005

Related U.S. Application Data
(60) Provisional application No. 60/569,577, filed on May 10, 2004.

(51) Int. Cl. B32B 3/14

(52) U.S. Cl. 428/55

(57) ABSTRACT

A mineral wool insulation having a facing formed by a polyester lamina and polyethylene to form a vapor barrier attached to the insulation according to various preferred embodiments including, one, wherein the polyethylene adheres to the polyester and to the mineral wool, and another, wherein the insulation, and not the vapor barrier, is pre-cut lengthwise, and a further embodiment wherein, the polyethylene adheres to the insulation and the polyester.

### FIELD OF THE INVENTION

The present invention pertains to mineral wool covered with a facing extending over one or more of its faces or surfaces. The mineral wool is used for heat insulation, while the facing is a vapor barrier on the heat insulation.

### BACKGROUND OF THE INVENTION

The construction industry sector uses mineral wool for either residential or industrial construction. More specifically, the mineral wool is used in large amounts for heat insulation of facades, ceilings, and vertical partitions. The mineral wool must be protected against an undesired increase in condensation within the insulation.

Mineral wool materials are known and used during construction of buildings which need suitable heat insulation. Mineral wools of low or average density have characteristics of lightness and flexibility performance, which attain high levels of heat insulation at moderate cost, and a minimum contribution of additional weight to the structures. The mechanical resistance of the mineral wool materials, and especially, resistance to tension or traction, is moderate, and sometimes insufficient for use in some applications for which they are intended. For that reason there is a requirement to equip mineral wool materials with facings that provide increased mechanical resistance, which facilitates manipulation and assembly.

Further, it is often required to use one or more materials that act as a vapor barrier, thus avoiding water vapor diffusion through the insulation materials, and causing undesirable condensation in the insulation materials as a result of a thermal gradient between cold and warm faces of the insulation materials. A vapor barrier that provides protection against condensation is a separate element of the heat insulation, in which case, vapor barrier foils usually are installed separately from the process of positioning the insulating materials. Alternatively, the vapor barrier is incorporated as a facing on insulation material, which increase the mechanical resistance to tearing and confer the required characteristics of vapor barrier protection against undesired condensation.

Commonly used facings are those constituted by layers (laminae) of Kraft paper adhered to mineral wool by means of a thermofusible (heat setting) adherent adhesive of the type consisting of polyethylenes, oxyasphalt or alloys thereof.

### SUMMARY OF THE INVENTION

The present invention pertains to mineral wool covered with a facing having one or more complexes formed of organic polymer laminates.

An embodiment of the present invention includes, a blanket or a panel built with such mineral wool material, and a facing consisting of two foils or films of organic polymers different in nature and properties.

A further embodiment of the present invention includes, mineral wool panels or blankets, with a vapor barrier, wherein the vapor barrier includes a double complex based on polyester and polyethylene as a facing on one of its faces, which provides a vapor barrier and, simultaneously, which resists tearing due to the punching strength of the facing.

The present invention includes the provision of a complex that can be used for a facing on insulation having mineral wools, which performs as a vapor barrier to protect against condensation, and that also has an increased parting strength to reduce the risk of tearing during the work manipulation thereof.

According to another preferred embodiment of the invention, the facing consists of a double lamina of materials such as polyester and polyethylene, united to each other, and applied on a surface of the mineral wool.

According to a further embodiment of the invention, a polyester layer constitutes an outer face of the product, and a polyethylene layer is in contact with the mineral wool. In a further preferred embodiment of the invention, the polyester layer has a thickness that can vary between 9 and 20 microns, and the surface weight of the polyethylene incorporated in the complex can vary between 20 and 50 g/m2.

A preferred facing of the preferred invention is constituted by a layer of polyester of 12 microns (17 g/m²) and one layer (lamina) of polyethylene of 40 g/m², offering a resistance to vapor of 13.89 mmHg m² day/g, that is to say, more than 15 times superior to 0.84 mmHg m² day/g that is obtained with the use of Kraft-bitumen, as determined by tests according to the NBE-CT-79 Basic Standard of the Construction.

The parting strength of this considered coating, is around 5.00 Kg/cm², that is to say, 67% greater than 3 Kg/cm² of a facing with Kraft paper of 60 g/m² and polyethylene of 30 g/m². Further, it is practical to designate this parting strength by a dimensional index (outbreak index) obtained as quotient between the obtained parting strength and the measurement of grams per surface area of the tested complex. As a result of the smaller measurement of grams per surface area (polyester 17 g/m²+polyethylene 40 g/m²=57 g/m²) of the facing proposed by the invention as opposed to the habitual one of 90 g/m² (Kraft 60 g/m²+polyethylene 30 g/m²), the outbreak index increases by 163% in the case of the new facing with respect to the previous one.

The facing or coating according to the invention protects the insulation product, making unnecessary the packing material that has been used to protect the insulation. Additionally, an improvement of the facility of cut of this facing and by extension of the end item is obtained. And one finally affords a substantial reduction of the packing material used in this type of product (generally polyethylene)

A double complex of polyester-polyethylene is adhered to a mineral wool substrate that is to be covered, by means of thermal activation, taking advantage of characteristics offered by the polyethylene as thermofusible or thermosetting adhesive and by the suitable thermal stability of the polyester at the temperatures where the polyethylene is activated. In a preferred embodiment, heat is applied to the facing, and through the polyester face, by means of direct contact on a hot surface that is used in addition to press the facing onto the mineral wool substrate to be faced. In other possible embodiments, the necessary heat for the thermal activation of polyethylene, until it attains an adherent state, can be provided by direct radiation on the polyethylene by means of heating equipment constituted by electrical resistance, infrared or similar radiation sources.

### BRIEF DESCRIPTION OF THE DRAWINGS

These and other embodiments and advantages of the invention will be made clear from the following description, described as non-limitative, illustrative example with reference to the accompanying drawings wherein:

FIG. 1 schematically shows a view in section of a final faced product according to the present invention;

FIG. 2 shows a stage of manufacture concerning the operation of applying the facing to the mineral wool base;

FIGS. 3a and 3b illustrate an embodiment of the finished product in which the mineral wool is longitudinally cut to predetermined widths, and

FIG. 4 illustrates roll formation of the finished product according to the invention.

### DESCRIPTION OF PREFERRED EMBODIMENT

The Basic Spanish Standard of Construction NBE-CT-79 establishes in its Annex 4, Section 4, 10, Table 4.3, that “can be considered as vapor barriers those laminar materials whose resistance to the steam is comprised between 10 and 230 MN s/g (0.86 and 20 mmHg m2 day/g)” and presents the values of resistance to vapor for some typically used materials:
Kraft Paper: 0.037 mmHg m² day/g
Kraft paper with oxyasphalt: 0.84 mmHg m² day/g

These typically used facings, based on laminae of Kraft paper, provides an increased mechanical resistance or strength of the mineral wool product to which they are adhered. However, they exhibit a low punching strength, leading to tearing of the facings during ordinary handling, or work manipulation, of the product. Such tears jeopardize the continuity of the vapor barrier.

The Standard UNE 57058:2002 establishes test conditions to determine the parting strength of this type of facings. A commonly used Kraft paper with a surface weight of 60 g/m², together with a layer of polyethylene of 30 g/m², for adhesion to mineral wool offers a parting strength of the order of 3 Kg/cm².

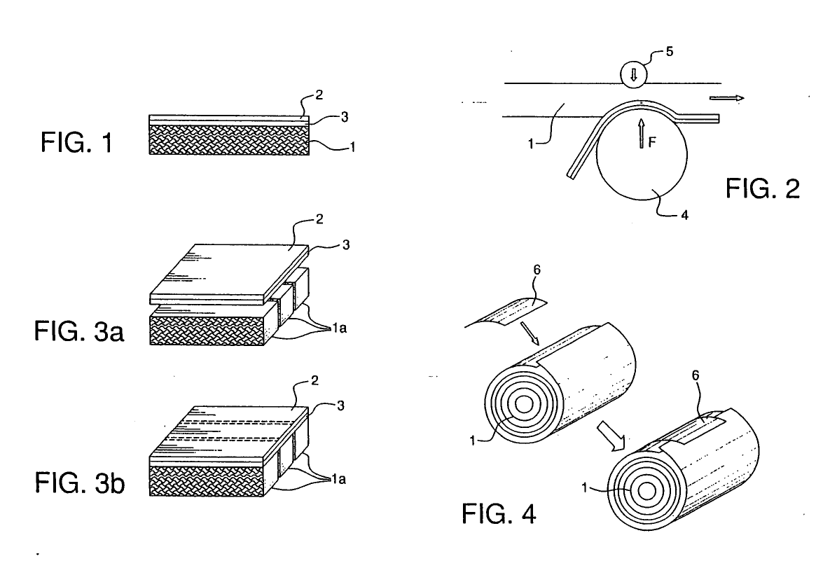

FIG. 1 discloses an example insulation product manufactured according to the description herein. The product consists of a mineral wool base (1), one face of which incorporates a proposed facing. Accordingly, it will be appreciated that this facing consists in two layers, indicated by means of the numerical references (2) and (3), which are superposed and maintained in intimate contact throughout their opposed surfaces. The inner laminate (3) of the facing, which is in contact with the face of the mineral wool panel or blanket (1), is of a material preferably consisting of polyethylene, selected for heat adhesion to the mineral wool, and its heat setting adhesive property. The external layer or laminate (2) consists of a film or layer of polyester covering the polyethylene.

FIG. 2 discloses the technique or process used for applying this facing on the mineral wool. This technique or process consists of, putting in contact the complex formed by polyethylene and polyester laminates (2) and (3), and providing and transferring an appropriate amount of heat, for example, by a heated roller (4), which provides the heat necessary to soften the internal lamina (2) of polyethylene until attaining its point of maximum adhesion, while simultaneously exerting pressure (indicated graphically by the arrow (F), so that the roller (4) with the aid of a counter-roller (S), the pressure exerted between the facing and the mineral wool substrate (1), ensures that a suitable adhesion is obtained therebetween.

In anticipation of possible diminution in width of the polyester foil, due to possible small shrinkage when heat is applied, an embodiment of the present invention uses a width of polyester-polyethylene facing slightly greater than the width of the mineral wool substrate to be faced, so that there is no loss of continuity of the vapor barrier proximate to the longitudinal edges of the substrate due to shrinkage.

FIGS. 3a and 3b disclose a product in accordance with the present invention, in which a mineral wool base substrate (1) is longitudinally pre-cut in a number of portions or bands (1a) that can be of the same or different width, and tied to each other by means of the uncut continuous complex of the facing (2) and (3) of polyester and polyethylene. With a product thus made, one obtains a product to be used, either in its total width without separation of the facing 2 along a cut, or to be easily divided along a cut into products of lesser width, using a simple blade to cut the facing 2, with no need to longitudinally cut the mineral wool substrate (1).

Finally, FIG. 4 shows a preferred embodiment of the packaging for containing a roll of the insulation product according to the present invention, when the product is coiled up on itself in the form of the roll. According to FIG., 4, the polyester and polyethylene facing (2) and (3) proposed by the invention also provides the additional practical advantage of being a packaging, which requires only a small plastic band (6) of self-adhesive securing the end of the roll (7) in place on the roll.

The invention has been described according to a preferred embodiment thereof. Therefore, it is susceptible to modification, without fundamentally altering the invention, especially with respect to the thickness and weight by surface unit of both employed material of polyester and polyethylene, and to the form of providing the heat to the facing for this application on the mineral wool substrate.

1. A method of making insulation, comprising:
superposing polyethylene and a layer of polyester to form a vapor barrier;
adhering the vapor barrier of polyethylene and polyester to mineral wool insulation.

2. The method of claim 1, further comprising:
cutting the insulation longitudinally prior to adhering the vapor barrier to the insulation.

3. The method of claim 1, further comprising:
rolling the insulation to form a roll packaged by the vapor barrier.

4. The method of claim 1, further comprising:
making the polyethylene and the layer of polyester wider than the mineral wool insulation prior to adhering the vapor barrier to the insulation.

5. The method of claim 1, further comprising:
adhering the vapor barrier and the mineral wool insulation to each other by applying pressure therebetween, while heating the polyethylene to soften and adhere the same to the polyester and the mineral wool insulation.

6. The method of claim 5, further comprising:
making the polyethylene and the layer of polyester wider than the mineral wool insulation prior to adhering the vapor barrier to the insulation.

7. The method of claim 4, further comprising:
making the polyethylene and the layer of polyester wider than the mineral wool insulation prior to adhering the vapor barrier to the insulation.

8. The method of claim 4, further comprising:
cutting the insulation longitudinally prior to adhering the vapor barrier to the insulation.

9. The method of claim 4, further comprising:
rolling the insulation to form a roll packaged by the vapor barrier.

10. Insulation comprising:
mineral wool, and a facing of polyester and polyethylene united to each other.

11. The insulation of claim 10, wherein
the width of the facing is greater than that of the mineral wool.

12. The insulation of claim 10, wherein the polyethylene adheres to the mineral wool.

13. The insulation of claim 10, wherein the mineral wool is longitudinally pre-cut.

14. The insulation of claim 10, wherein the mineral wool is pre-cut.
